(19) United States
(12) Patent Application Publication
(10) Pub. No.: US 2012/0293951 A1
(43) Pub. Date: Nov. 22, 2012

(54) RACK MOUNTED COMPUTER SYSTEM AND COOLING STRUCTURE THEREOF

(75) Inventor: Ben-Chiao Jai, Taoyuan Hsien (TW)

(73) Assignee: DELTA ELECTRONICS, INC., Taoyuan Hsien (TW)

(21) Appl. No.: 13/197,936

(22) Filed: Aug. 4, 2011

Related U.S. Application Data
(60) Provisional application No. 61/486,398, filed on May 16, 2011.

(51) Int. Cl. G06F 1/20

(52) U.S. Cl. 361/679.53

(57) ABSTRACT

A rack mounted computer system is disclosed and comprises a rack, at least one network switch and a cooling structure. The rack comprises an interior including at least one first compartment for installing the first compartment. The cooling structure is disposed in the interior of the rack and comprises a first airflow passage, a second airflow passage and an airflow directing mechanism. The first airflow passage and the second airflow passage are disposed in the first compartment and in fluid communication with an interior of the network switch. The airflow directing mechanism comprises a first blocking device selectively disposed at an entrance or an outlet of the first airflow passage and a second blocking device selectively disposed at an outlet or an entrance of the second airflow passage. The airflow directing mechanism is configured for directing the chilly airflow to flow through the first airflow passage, the interior of the network switch and the second airflow passage or through the second airflow passage, the interior of the network switch and the first airflow passage.

### CROSS-REFERENCE TO RELATED APPLICATION

This application claims the benefit of U.S. Provisional Application No. 61/486, 398 filed on May 16, 2011, and entitled “RACK MOUNTED COMPUTER SYSTEM”, the entirety of which is hereby incorporated by reference.

### FIELD OF THE INVENTION

The present invention relates to a rack mounted computer system, and more particularly to a rack mounted computer system with a cooling structure for introducing chilly airflow to cool the IT equipments installed inside the rack.

### BACKGROUND OF THE INVENTION

With increasing development of information industries and networks, the services provided through networks are becoming more and more popular in various applications. For providing intensive network applications, the numbers of computers or servers of the data center need to be increased to transmit, process, access and communicate data at high speed. A data center is a facility designed for housing one or more rack mounted computer system and associated equipments. Each rack mounted computer system includes a rack, which can accommodate or position the modular IT equipments (i.e. modular servers or network switch) in an organized and closely stacked arrangement so that the space can be utilized efficiently. Typically, the modular IT equipments are retractably inserted from the front of the rack, and various cables are coupled to the IT equipments at the front of the rack. These cables may be routed to other equipments within the rack or may be routed to other devices external to the rack.

The modular IT equipments (i.e. network switch or modular server) mounted in the rack tend to generate large amounts of heat that needs to be exhausted away from the IT equipments effectively in order to maintain the IT equipments in proper operation and prevent damage thereto. As the IT equipment becomes more densely packed within the casing thereof, the quantities of heat have continued to increase so that the heat management or cooling design of the rack mounted computer system has become more and more important. Typically, the chilly airflow provided from the air conditioner of the data center flows through the front of the rack for cooling the modular servers and the network switch mounted inside the rack. After the heat exchange is performed, the hot airflow is then exhausted through one or more outlet in the rear of the rack. However, when the network switch is installed into a corresponding receiving space of the rack, the casing of the network switch may cover and seal the entrance of the receiving space totally so that the chilly airflow from the air conditioner of the data center can't be directed to pass through the interior of the network switch for exhausting the heat away from the interior of the network switch. Therefore, the IT equipment inside the rack can't be cooled down effectively by using the chilly airflow from the air conditioner of the data center, and the efficiency of cooling the IT equipment and the rack mounted computer system can't be enhanced.

Therefore, there is a need of providing a rack mounted computer system with a cooling structure for introducing chilly airflow provided from the air conditioner of the data center to cool the IT equipments installed inside the rack so as to obviate the drawbacks encountered from the prior art.

### SUMMARY OF THE INVENTION

It is an object of the present invention to provide a rack mounted computer system with a cooling structure for introducing chilly airflow provided from the air conditioner of the data center to cool the interior of the network switch inside the rack.

It is another object of the present invention to provide a rack mounted computer system with a cooling structure for introducing chilly airflow to cool the IT equipments inside the rack efficiently.

In accordance with an aspect of the present invention, there is provided a rack mounted computer system. The rack mounted computer system comprises a rack, at least one network switch and a cooling structure. The rack comprises an interior including at least one first compartment. The network switch is installed in the first compartment, wherein the network switch comprises a casing having a first sidewall and a second sidewall opposite to the first sidewall, and the casing has at least one first ventilation hole formed at the first sidewall and at least one second ventilation hole formed at the second sidewall. The cooling structure is disposed in the interior of the rack and configured to introduce chilly airflow to cool the network switch. The cooling structure comprises a first airflow passage, a second airflow passage and an airflow directing mechanism. The first airflow passage and the second airflow passage are disposed in the first compartment and in fluid communication with an interior of the casing of the network switch through the first ventilation hole and the second ventilation hole, respectively. The airflow directing mechanism comprises a first blocking device selectively disposed at an entrance or an outlet of the first airflow passage and a second blocking device selectively disposed at an outlet or an entrance of the second airflow passage. The airflow directing mechanism is configured for directing the chilly airflow to flow through the first airflow passage, the interior of the network switch and the second airflow passage or through the second airflow passage, the interior of the network switch and the first airflow passage.

In accordance with another aspect of the present invention, there is provided a cooling structure of a rack mounted computer system. The rack mounted computer system includes a rack and at least one network switch, the rack comprises an interior comprising a first compartment for installing the at least one network switch, the network switch comprises a casing having a first sidewall and a second sidewall opposite to the first sidewall, and the casing has at least one first ventilation hole formed at the first sidewall and at least one second ventilation hole formed at the second sidewall. The cooling structure of the rack mounted computer system comprises a first airflow passage, a second airflow passage and airflow directing mechanism. The first airflow passage and the second airflow passage are disposed in the first compartment and in fluid communication with an interior of the casing of the network switch through the first ventilation hole and the second ventilation hole, respectively. The airflow directing mechanism comprises a first blocking device selectively disposed at an entrance or an outlet of the first airflow passage and a second blocking device selectively disposed at an outlet or an entrance of the second airflow passage. The airflow directing mechanism is configured for directing the chilly airflow to flow through the first airflow passage, the interior of the network switch and the second airflow passage or through the second airflow passage, the interior of the network switch and the first airflow passage.

In accordance with a further aspect of the present invention, there is provided a rack mounted computer system. The rack mounted computer system comprises a rack, a plurality of first IT equipments, at least one second IT equipment and a cooling structure. The rack comprises an interior, wherein the interior comprises at least one first compartment and a plurality of second compartments. The first IT equipments are installed in the second compartments, and each first IT equipment has an enclosure having a first airflow path. The second IT equipment is installed in the first compartment. The cooling structure is disposed in the interior of the rack and comprises a first airflow passage, a second airflow passage and an airflow directing mechanism. The first airflow passage and the second airflow passage are disposed in the first compartment and in fluid communication with an interior of the second IT equipment, respectively. The airflow directing mechanism is disposed in the first airflow passage and the second airflow passage for defining a second airflow path selectively extending through the first airflow passage, the interior of the second IT equipment and the second airflow passage in order or extending through the second airflow passage, the interior of the second IT equipment and the first airflow passage in order. The first airflow path and the second airflow path are configured to introduce a chilly airflow and exhaust respective hot airflow out of the rack in the same exhaust direction.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a rack mounted computer system with a cooling structure according to an embodiment of the present invention;

FIG. 2 schematically illustrates the rack mounted computer system of FIG. 1 employing a cable management mechanism for managing and securing cables between the network switch and the modular servers;

FIG. 3 shows the cooling airflow passing through the rack mounted computer system of FIG. 1;

FIGS. 4A and 4B schematically illustrate the cooling structure of the rack mounted computer system for introducing chilly airflow to cool the network switch inside the rack; and

FIG. 5 schematically illustrates another cooling structure of the rack mounted computer system for introducing chilly airflow to cool the network switch inside the rack.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

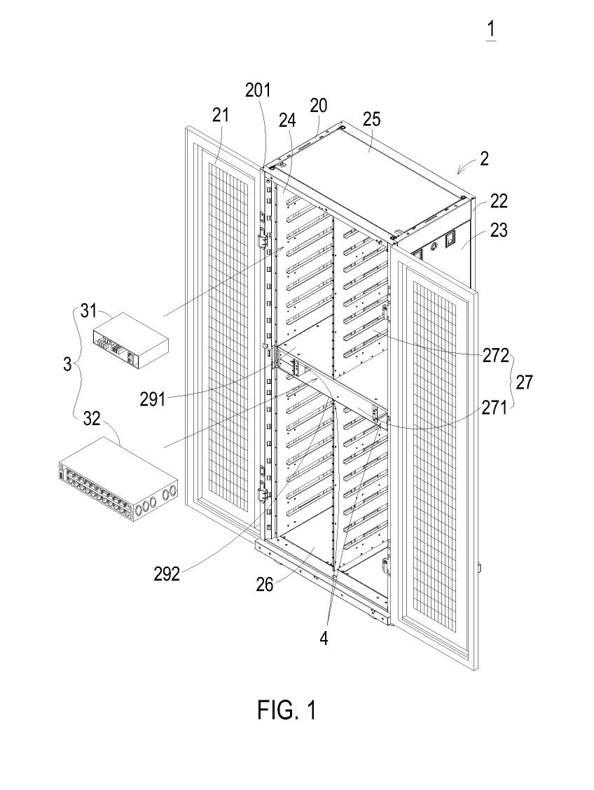

FIG. 1 is a schematic view illustrating a rack mounted computer system with a cooling structure according to an embodiment of the present invention. The rack mounted computer system 1 includes a rack 2, a plurality of retractable IT equipments 3 (information technology and telecommunications equipment), and a cooling structure 4. The IT equipments 3 include a plurality of first IT equipments such as modular servers 31 and one or more second IT equipment such as modular network switch 32. The rack 2 includes a frame assembly 20, a front door 21, a rear door 22, a first side panel 23, a second side panel 24 opposite to the first side panel 23, a top panel 25, a bottom panel 26 and an interior 27. The front door 21 and the rear door 22 are mesh panels or doors constructed to facilitate airflow passage through the interior 27 of the rack 2. The first side panel 23, the second side panel 24, the top panel 25 and the bottom panel 26 are respectively made of a solid construction that can obstruct airflow. The frame assembly 20 includes a front door frame 201, a rear door frame (not shown) and a plurality of side frames (not shown). The front door 21 and the rear door 22 are pivotally connected to the front door frame 201 and the rear door frame of the frame assembly 20, respectively. The interior 27 of the rack 2 is divided into at least one first compartment 271 for installing the one or more modular network switch 32 and a plurality of second compartments 272 for installing the modular servers 31. The first compartment 271 is defined by the first side panel 23, the second side panel 24, a first partition panel 291 and a second partition panel 292. Preferably, one modular network switch 32 is installed into the first compartment 271 of the rack 2.

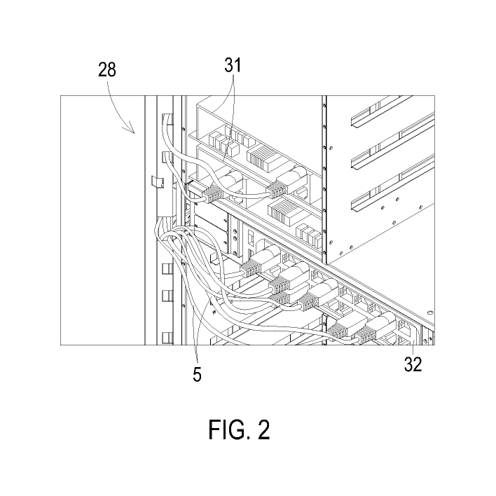

FIG. 2 schematically illustrates the rack mounted computer system of FIG. 1 employing a cable management mechanism for managing and securing cables between the network switch and the modular servers. As shown in FIGS. 1 and 2, the modular network switch 32 is installed into a corresponding receiving space of the rack 2, for example the first compartment 271 of the rack 2. Preferably, the first compartment 271 is arranged at the middle area of the rack 2. The modular servers 31 are retractably installed into the corresponding receiving spaces of the rack 2, for example the second compartments 272 of the rack 2. The rack 2 further includes a cable management mechanism 28 for managing and securing the cables 5 connected between the network switch 32 and the modular servers 31.

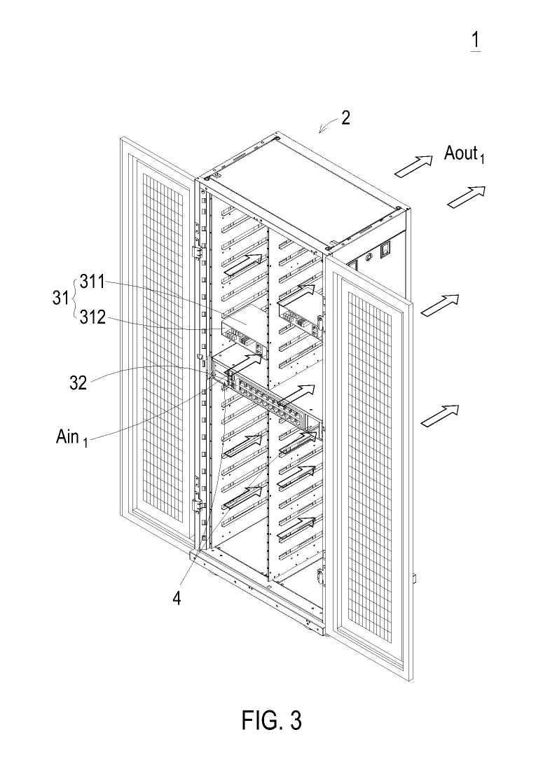

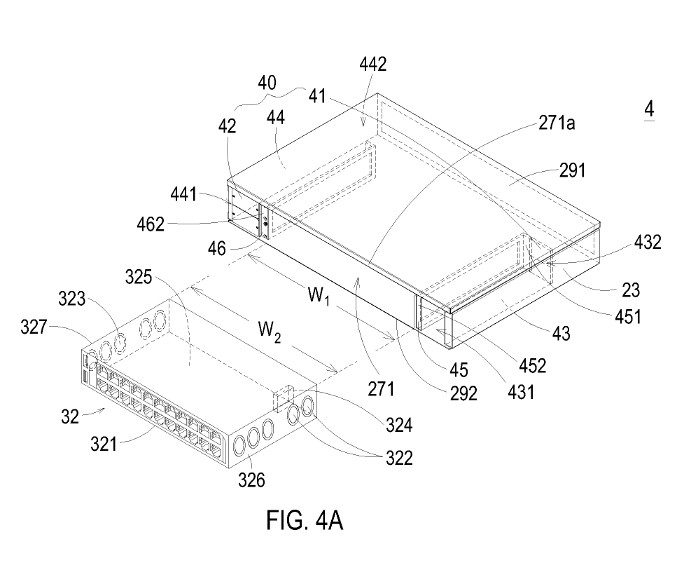

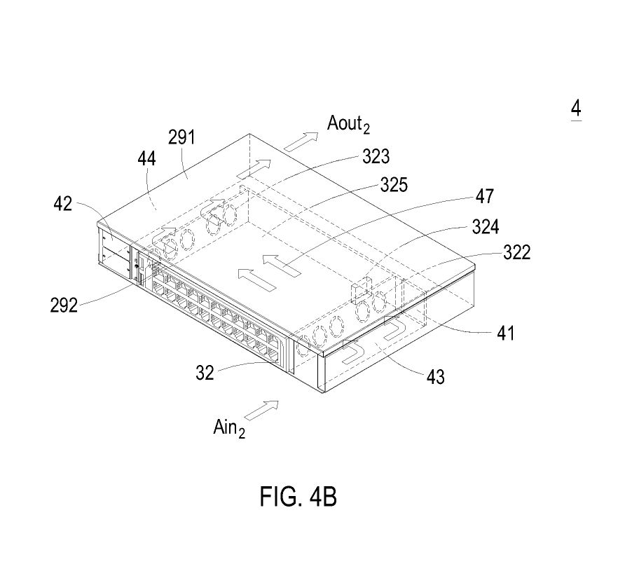

FIG. 3 shows the cooling airflow passing through the rack mounted computer system of FIG. 1; and FIGS. 4A and 4B schematically illustrate the cooling structure of the rack mounted computer system for introducing chilly airflow to cool the network switch inside the rack. As shown in FIGS. 1, 3, 4A and 4B, the modular servers 31 are installed into the second compartments 272 of the rack and the modular server 31 has an enclosure 311 having a first airflow path 312. When the network switch 32 is installed into first compartment 271 of rack 2, the cooling structure 4 is formed and defined in the interior 27 of the rack 2 for introducing chilly airflow to pass through the interior of the network switch 32 and cool the network switch 32. The cooling structure 4 includes an airflow directing mechanism 40, a first airflow passage 43 and a second airflow passage 44. The airflow directing mechanism 40 includes a first blocking device 41 and a second blocking device 42. The first blocking device 41 is selectively disposed at an entrance 431 or an outlet 432 of the first airflow passage 43, and the second blocking device 42 is selectively disposed at an outlet 442 or an entrance 441 of the second airflow passage 44. Namely, the airflow directing mechanism 40 is disposed in the first airflow passage 43 and the second airflow passage 44 for defining a second airflow path 47 selectively extending through the first airflow passage 43, an interior 325 of the network switch 32 and the second airflow passage 44 in order or extending through the second airflow passage 44, the interior 325 of the network switch 32 and the first airflow passage 43 in order. The airflow directing mechanism 40 is configured for directing a chilly airflow to flow through the first airflow passage 41, the interior 325 of the one or more network switch 32 and the second airflow passage 44 or through the second airflow passage 44, the interior 325 of the one or more network switch 32 and the first airflow passage 43.

The network switch 32 includes a casing 321 having a first sidewall 326 and a second sidewall 327 opposite to the first sidewall 326. The casing 321 of the network switch 32 has at least one first ventilation hole 322 formed at the first sidewall 326 and at least one second ventilation hole 323 formed at the second sidewall 327. The network switch 32 further includes a plurality of fans 324 disposed inside the interior 325 of the casing 321 and arranged adjacent to the first ventilation holes 322 or the second ventilation holes 323 for driving the airflow to flow through the interior 325 of the casing 321. When the network switch 32 is installed into the first compartment 271 of rack 2, the first airflow passage 43 and the second airflow passage 44 are defined inside the first compartment 271 and disposed adjacent to two opposite sides of the network switch 32. The first airflow passage 43 can be defined by the first sidewall 326 of the network switch 32, the first partition panel 291, the second partition panel 292 and the first side panel 23. The second airflow passage 44 can be defined by the second sidewall 327 of the network switch 32, the first partition panel 291, the second partition panel 292 and the second side panel 24. The first airflow passage 43 is in fluid communication with the interior 325 of the casing 321 through the first ventilation hole 322, and the second airflow passage 44 is in fluid communication with the interior 325 of the casing 321 through the second ventilation holes 323.

In an embodiment, the cooling structure 4 further includes a first reinforcement device 45 and a second reinforcement device 46. The first reinforcement device 45 and the second reinforcement device 46 are disposed in the first compartment 271 of rack 2 and separated apart with each other for dividing the space of the first compartment 271 into three sections. The middle section of the first compartment 271 is configured for installing the network switch 32, and the other two sections are used as the first airflow passage 43 and the second airflow passage 44. The middle section of the first compartment 271 has an entrance 271a with a first width W₁ equal to a second width W₂ of the network switch 32. The first blocking device 41 of the airflow directing mechanism 40 is secured to a first ear member 451 of the first reinforcement device 45 and configured to seal the outlet 432 of the first airflow passage 43. Preferably, the first blocking device 41 is a blocking plate. The second block device 42 of the airflow directing mechanism 40 is secured to a second ear member 462 of the second reinforcement device 46 and configured to seal the entrance 441 of the second airflow passage 44. Preferable, the second block device 42 is a blocking plate.

The modular servers 31 are installed into the second compartments 272. The modular servers 31 define a respective plurality of generally parallel airflow paths through the modular servers 31. When the chilly airflow provided from the air conditioner of the data center is directed to the interior 27 of the rack 2 from the front of the rack 2, a portion of the chilly airflow Aᵢₙ₁ can flow into the first airflow paths 312 of the modular servers 31 and the other portion of the chilly airflow Aᵢₙ₂ can flow into the entrance 431 of the first airflow passage 43 (i.e. the second airflow path 47). The chilly airflow Aᵢₙ₁ flowing inside the modular servers 31 can cool the interior of the modular servers 31 and become hot airflow, and the hot airflow Aₒᵤₜ₁ is directed to the rear of the rack 2 and exhausted out of the rack 2 directly. The chilly airflow Aᵢₙ₂ flowing inside the first airflow passage 43 can be directed to the first ventilation holes 322 of the casing 321 of the network switch 32 by the first blocking device 41 of the airflow directing mechanism 40 and pass through the interior 325 of the network switch 32. Therefore, the heat inside the interior 325 of the network switch 32 can be exhausted. Then, the hot airflow is exhausted out of the network switch 32 through the second ventilation holes 323 and flows into the second airflow passage 44. Finally, the hot airflow Aₒᵤₜ₂ is directed to the rear of the rack 2 by the second blocking device 42 of the airflow directing mechanism 40 and exhausted outside the rack 2. Namely, the first airflow paths 312 and the second airflow path 47 are configured to exhaust respective hot airflow Aₒᵤₜ₁, Aₒᵤₜ₂ out of the rack 2 in the same exhaust direction (i.e. in the same side of the rack 2).

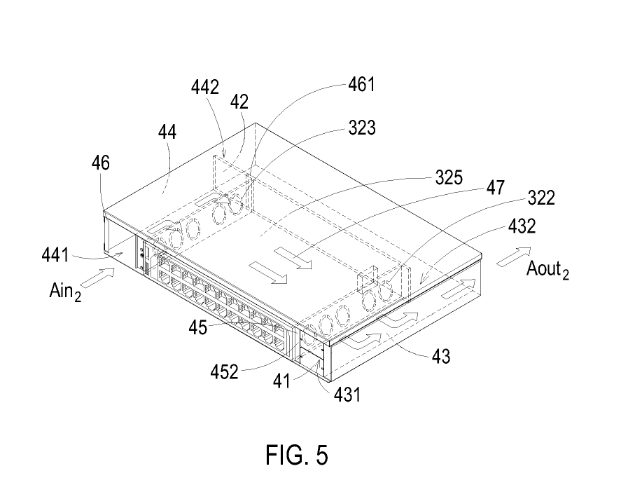

Alternatively, as shown in FIG. 5 and referring to FIGS. 1, 3, 4A and 4B, the first blocking device 41 of the airflow directing mechanism 40 is secured to a second ear member 452 of the first reinforcement device 45 and configured to seal the entrance 431 of the first airflow passage 43, and the second block device 42 of the airflow directing mechanism 40 is secured to a first ear member 461 of the second reinforcement device 46 and configured to seal the outlet 442 of the second airflow passage 44. When the chilly airflow provided from the air conditioner of the data center is directed to the interior 27 of the rack 2 from the front of the rack 2, a portion of the chilly airflow Aᵢₙ₁ can flow into the first airflow paths 312 of the modular servers 31 directly and the other portion of the chilly airflow Aᵢₙ₂ can flow into the entrance 441 of the second airflow passage 44 (i.e. the second airflow path 47). The chilly airflow Aᵢₙ₁ flowing inside the modular servers 31 can cool the interior of the modular servers 31 and become hot airflow, and the hot airflow Aₒᵤₜ₁ is directed to the rear of the rack 2 and exhausted out of the rack 2 directly. The chilly airflow Aᵢₙ₂ flowing inside the second airflow passage 44 can be directed to the second ventilation holes 323 of the casing 321 of the network switch 32 by the second blocking device 42 of the airflow directing mechanism 40 and pass through the interior 325 of the network switch 32. Therefore, the heat inside the interior 325 of the network switch 32 can be exhausted. Then, the hot airflow is exhausted out of the network switch 32 through the first ventilation holes 322 and flows into the first airflow passage 43. Finally, the hot airflow Aₒᵤₜ₂ is directed to the rear of the rack 2 by the first blocking device 41 of the airflow directing mechanism 40 and exhausted outside the rack 2. Namely, the first airflow paths 312 and the second airflow path 47 are configured to exhaust respective hot airflow Aₒᵤₜ₁, Aₒᵤₜ₂ out of the rack 2 in the same exhaust direction (i.e. in the same side of the rack 2).

Alternatively, the cooling structure can be employed to cool the modular servers within the rack. By using the first blocking device and the second blocking device, the first airflow passage and the second airflow passage can be formed and in fluid communication with the interior of the network switch so that the chilly airflow can be directed to pass through the interior of the IT equipment and cool the IT equipment efficiently.

From the above description, the present invention provide a rack mounted computer system with a cooling structure for introducing chilly airflow provided from the air conditioner of the data center to cool the interior of the network switch inside the rack. The cooling structure of the rack mounted computer system can introduce chilly airflow to cool the IT equipments inside the rack efficiently.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A rack mounted computer system, comprising:
a rack comprising an interior, wherein the interior comprises at least one first compartment;
at least one network switch installed in the first compartment, wherein the network switch comprises a casing having a first sidewall and a second sidewall opposite to the first sidewall, and the casing has at least one first ventilation hole formed at the first sidewall and at least one second ventilation hole formed at the second sidewall; and
a cooling structure disposed in the interior of the rack and configured to introduce chilly airflow to cool the network switch, and comprising:
a first airflow passage and a second airflow passage disposed in the first compartment and in fluid communication with an interior of the casing of the network switch through the first ventilation hole and the second ventilation hole, respectively; and
an airflow directing mechanism comprising a first blocking device selectively disposed at an entrance or an outlet of the first airflow passage and a second blocking device selectively disposed at an outlet or an entrance of the second airflow passage, wherein the airflow directing mechanism is configured for directing the chilly airflow to flow through the first airflow passage, the interior of the network switch and the second airflow passage or through the second airflow passage, the interior of the network switch and the first airflow passage.

2. The rack mounted computer system according to claim 1, further comprising a plurality of modular servers, and wherein the interior of the rack comprises a plurality of second compartments for installing the modular servers therein.

3. The rack mounted computer system according to claim 1, wherein the network switch further includes at least one fan disposed inside the interior of the casing and arranged adjacent to the first ventilation hole or the second ventilation hole for driving the airflow through the interior of the casing.

4. The rack mounted computer system according to claim 1, wherein the first blocking device and the second blocking device are blocking plates.

5. The rack mounted computer system according to claim 1, wherein the rack comprises a frame assembly, a front door, a rear door, a first side panel, a second side panel opposite to the first side panel, a top panel, a bottom panel, a first partition panel and a second partition panel.

6. The rack mounted computer system according to claim 5, wherein the front door and the rear door are mesh panels or doors.

7. The rack mounted computer system according to claim 5, wherein the first compartment is defined by the first side panel, the second side panel, the first partition panel and the second partition panel.

8. The rack mounted computer system according to claim 7, wherein the first airflow passage is defined by the first sidewall of the network switch, the first partition panel, the second partition panel and the first side panel, and the second airflow passage is defined by the second sidewall of the network switch, the first partition panel, the second partition panel and the second side panel.

9. The rack mounted computer system according to claim 1, wherein the first blocking device is secured to the rack and/or the network switch and configured to seal the entrance or the outlet of the first airflow passage.

10. The rack mounted computer system according to claim 1, wherein the second blocking device is secured to the rack and/or the network switch and configured to seal the outlet or the entrance of the second airflow passage.

11. The rack mounted computer system according to claim 1, wherein the cooling structure further comprises a first reinforcement device and a second reinforcement device disposed in the first compartment of the rack and separated apart with each other for dividing the first compartment into three sections.

12. The rack mounted computer system according to claim 11, wherein a middle section of the first compartment is configured for installing the network switch, and the other two sections are used as the first airflow passage and the second airflow passage.

13. The rack mounted computer system according to claim 13, wherein the middle section of the first compartment has an entrance with a first width equal to a second width of the network switch.

14. The rack mounted computer system according to claim 11, wherein the first blocking device is secured to a first ear member of the first reinforcement device and configured to seal the outlet of the first airflow passage, and the second block device is secured to a second ear member of the second reinforcement device and configured to seal the entrance of the second airflow passage.

15. The rack mounted computer system according to claim 11, wherein the first blocking device is secured to a second ear member of the first reinforcement device and configured to seal the entrance of the first airflow passage, and the second block device is secured to a first ear member of the second reinforcement device and configured to seal the outlet of the second airflow passage.

16. A cooling structure of a rack mounted computer system, wherein the rack mounted computer system includes a rack and at least one network switch, the rack comprises an interior comprising a first compartment for installing the at least one network switch, the network switch comprises a casing having a first sidewall and a second sidewall opposite to the first sidewall, and the casing has at least one first ventilation hole formed at the first sidewall and at least one second ventilation hole formed at the second sidewall, the cooling structure comprising:
a first airflow passage and a second airflow passage disposed in the first compartment and in fluid communication with an interior of the casing of the network switch through the first ventilation hole and the second ventilation hole, respectively; and
an airflow directing mechanism comprising a first blocking device selectively disposed at an entrance or an outlet of the first airflow passage and a second blocking device selectively disposed at an outlet or an entrance of the second airflow passage, wherein the airflow directing mechanism is configured for directing the chilly airflow to flow through the first airflow passage, the interior of the network switch and the second airflow passage or through the second airflow passage, the interior of the network switch and the first airflow passage.

17. A rack mounted computer system, comprising:
a rack comprising an interior, wherein the interior comprises at least one first compartment and a plurality of second compartments;
a plurality of first IT equipments installed in the second compartments, wherein each first IT equipment has an enclosure having a first airflow path therein;
at least one second IT equipment installed in the first compartment; and
a cooling structure disposed in the interior of the rack and comprising:
a first airflow passage and a second airflow passage disposed in the first compartment and in fluid communication with an interior of the second IT equipment, respectively; and
an airflow directing mechanism disposed in the first airflow passage and the second airflow passage for defining a second airflow path selectively extending through the first airflow passage, the interior of the second IT equipment and the second airflow passage in order or extending through the second airflow passage, the interior of the second IT equipment and the first airflow passage in order;
wherein the first airflow path and the second airflow path are configured to introduce a chilly airflow thereinto and exhaust respective hot airflow out of the rack in same exhaust direction.

18. The rack mounted computer system according to claim 17, wherein the first IT equipment is modular server and the second IT equipment is network switch.

19. The rack mounted computer system according to claim 17, wherein the airflow directing mechanism comprises a first blocking device selectively disposed at an entrance or an outlet of the first airflow passage and a second blocking device selectively disposed at an outlet or an entrance of the second airflow passage.

20. The rack mounted computer system according to claim 17, wherein the second IT equipment comprises a casing having a first sidewall and a second sidewall opposite to the first sidewall, and the casing has at least one first ventilation hole formed at the first sidewall and at least one second ventilation hole formed at the second sidewall.
